(19) United States
(12) Patent Application Publication
(10) Pub. No.: US 2026/0058303 A1
(43) Pub. Date: Feb. 26, 2026

(54) FIRE EXTINGUISHING APPARATUS AND BATTERY CELL

(71) Applicant: Isuzu Motors Limited, Yokohama-shi (JP)

(72) Inventor: Takumi KOMIYAMA, Fujisawa-shi (JP)

(73) Assignee: Isuzu Motors Limited, Yokohama-shi (JP)

(21) Appl. No.: 19/305,826

(22) Filed: Aug. 21, 2025

(30) Foreign Application Priority Data
Aug. 22, 2024 (JP) 2024-140783

(51) Int. Cl. H01M 50/383; H01M 10/643; H01M 10/653

(52) U.S. Cl. CPC H01M 50/383; H01M 10/643; H01M 10/653

(57) ABSTRACT

A fire extinguishing apparatus includes an insulating sheet disposed on a tab at a mounting surface of a battery cell on which an electrode is mounted, the tab being connected to the electrode, a fire extinguishing sheet disposed on the insulating sheet and formed of an alkali metal, and a fixing section to which the insulating sheet and the fire extinguishing sheet are fixed in a state of being electrically insulated from each other.

### RELATED APPLICATION(S)

This application claims the benefit of priority of Japanese Patent Application No. 2024-140783 filed on Aug. 22, 2024, the contents of the above application are all incorporated by reference as if fully set forth herein in their entirety.

### TECHNICAL FIELD

The present disclosure relates to a fire extinguishing apparatus and a battery cell.

### BACKGROUND ART

Conventionally, there is known a phenomenon of “thermal runaway” in a battery cell (for example, a lithium-ion battery cell) in which heat generation due to an internal short circuit or an external short circuit causes further heat generation and the temperature continues to increase. In addition, there is known a phenomenon known as “thermal propagation” in which a vent gas generated by vaporization of an electrolytic solution in a battery cell is discharged to the outside during a thermal runaway, whereby the thermal runaway spreads to a surrounding battery cell.

As a conventional technique for suppressing thermal propagation, for example, a fire-proof vent port (Flame Arresting Vent Port) that can be attached to an electrode-surface of a battery cell is known. However, this invention does not consider that battery cells are connected in series and/or parallel by tabs (bus bars), and cannot be attached to tabbed battery cells. In addition, conventionally, there are many cases in which a vent port is provided in a battery module or a battery pack (for example, refer to Patent Literatures (hereinafter, referred to as “PTLs”) 1 and 2).

That is, conventionally, there is no thermal propagation suppression means that can be retrofitted to a tabbed battery cell.

### CITATION LIST

### Patent Literature

PTL 1
Japanese Unexamined Patent Application Publication (Translation of PCT Application) No. 2024-508132
PTL 2
Japanese Unexamined Patent Application Publication (Translation of PCT Application) No. 2024-525104

### SUMMARY OF INVENTION

### Technical Problem

An object of one aspect of the present disclosure is to provide a fire extinguishing apparatus and a battery cell that can be retrofitted to a tabbed battery cell and that can contribute to suppression of thermal propagation for each battery cell.

### Solution to Problem

A fire extinguishing apparatus according to one aspect of the present disclosure includes: an insulating sheet disposed on a tab at a mounting surface of a battery cell on which an electrode is mounted, the tab being connected to the electrode; a fire extinguishing sheet disposed on the insulating sheet and formed of an alkali metal; and a fixing portion to which the insulating sheet and the fire extinguishing sheet are fixed in a state of being electrically insulated from each other.

A fire extinguishing apparatus according to one aspect of the present disclosure includes: a fire extinguishing sheet composed of an insulator and an alkali metal and disposed on a tab at a mounting surface of a battery cell on which an electrode is mounted, the tab being connected to the electrode; and a fixing section to which the fire extinguishing sheet is fixed.

### Advantageous Effects of Invention

According to the present disclosure, it is possible to retrofit a tabbed battery cell, and it is possible to contribute to suppression of thermal propagation for each battery cell.

### BRIEF DESCRIPTION OF DRAWINGS

FIG. 1 is a perspective view schematically showing a state in which a fire extinguishing apparatus according to Embodiment 1 of the present disclosure is attached to a battery cell;

FIG. 2 is a side view schematically showing a state in which the fire extinguishing apparatus according to Embodiment 1 of the present disclosure is attached to a battery cell;

FIG. 3 is a top view schematically showing a state in which the fire extinguishing apparatus according to Embodiment 1 of the present disclosure is attached to a battery cell;

FIG. 4 is a side view schematically showing the fire extinguishing apparatus according to Embodiment 1 of the present disclosure;

FIG. 5 is a perspective view schematically showing a state in which a fire extinguishing apparatus according to Embodiment 2 of the present disclosure is attached to a battery cell;

FIG. 6 is a side view schematically showing a state in which the fire extinguishing apparatus according to Embodiment 2 of the present disclosure is attached to a battery cell;

FIG. 7 is a top view schematically showing a state in which the fire extinguishing apparatus according to Embodiment 2 of the present disclosure is attached to a battery cell;

FIG. 8 is a side view schematically showing the fire extinguishing apparatus according to Embodiment 2 of the present disclosure;

FIG. 9 is a side view schematically showing a state in which a fire extinguishing apparatus according to a variation of Embodiment 1 of the present disclosure is attached to a battery cell; and

FIG. 10 is a side view schematically showing a state in which a fire extinguishing apparatus according to a variation of Embodiment 2 of the present disclosure is attached to a battery cell.

### DESCRIPTION OF EMBODIMENTS

Hereinafter, an embodiment of the present disclosure will be described with reference to the drawings. Note that the same components are provided with the same reference signs between the figures, and descriptions of these components are omitted as appropriate.

### Embodiment 1

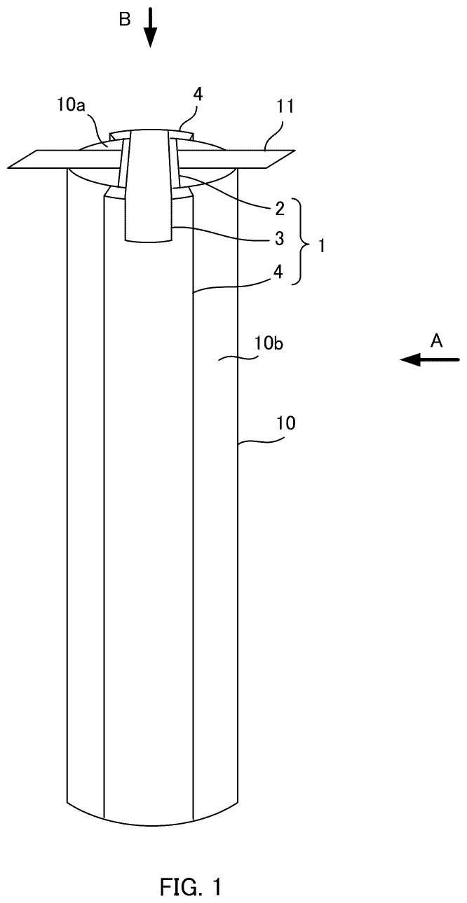

Fire extinguishing apparatus 1 and battery cell 10 according to Embodiment 1 will be described with reference to FIGS. 1 to 4.

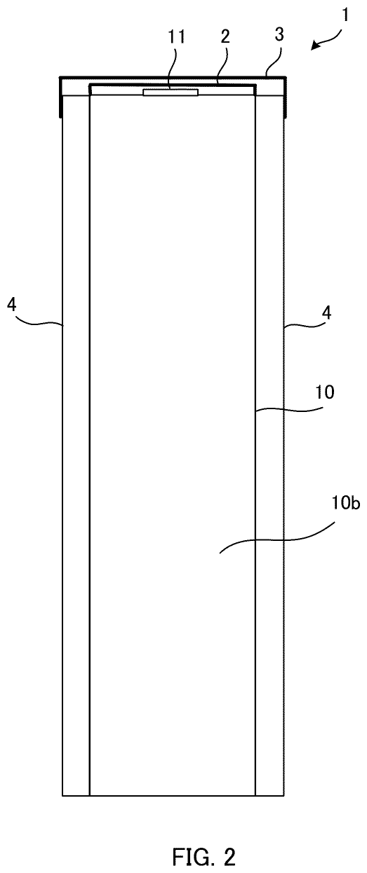

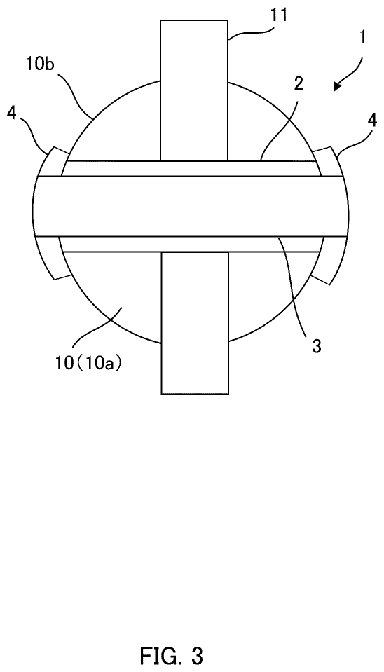

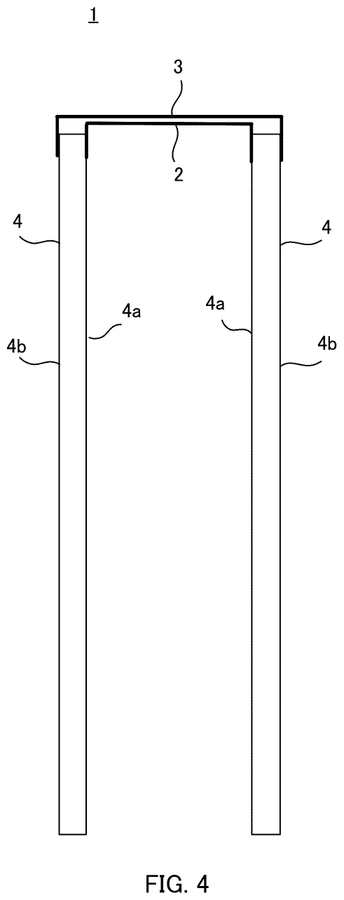

FIG. 1 is a perspective view schematically showing a state in which fire extinguishing apparatus 1 according to Embodiment 1 is attached to battery cell 10. FIG. 2 is a side view schematically illustrating a state in which fire extinguishing apparatus 1 according to Embodiment 1 is attached to battery cell 10 (a view seen from a direction indicated by arrow A in FIG. 1). FIG. 3 is a top view schematically illustrating a state in which fire extinguishing apparatus 1 according to Embodiment 1 is attached to battery cell 10 (a view seen from a direction indicated by arrow B in FIG. 1). FIG. 4 is a side view schematically illustrating fire extinguishing apparatus 1 according to Embodiment 1.

Battery cells 10 shown in FIGS. 1 to 3 are, for example, lithium-ion battery cells. As shown in FIGS. 1 to 3, battery cell 10 has a cylindrical shape. Although not shown, an electrode (for example, a positive electrode) is provided on upper surface 10a of battery cell 10. Tab 11 is connected to the electrode. Note that, although both ends of tab 11 are illustrated in FIGS. 1 to 3 for convenience, at least one end portion may extend more than illustrated and be connected to an electrode (not illustrated) of another battery cell disposed next to the battery cell.

Fire extinguishing apparatus 1 shown in FIGS. 1 to 4 is attached to battery cell 10, and is an apparatus for extinguishing fire in a case where ignition by a vent gas occurs in battery cell 10.

As shown in FIGS. 1 to 4, fire extinguishing apparatus 1 includes insulating sheet 2, fire extinguishing sheet 3, and structural members 4.

Insulating sheet 2 is a rectangular sheet member and is formed of a known insulator (for example, resin or the like). As shown in FIGS. 1 to 3, insulating sheet 2 is disposed on tab 11 at upper surface 10a of battery cell 10 (in other words, at the surface on which the electrode is disposed). In FIG. 2, tab 11 and insulating sheet 2 are spaced apart from each other for the sake of clarity, but tab 11 and insulating sheet 2 may be in contact with each other.

Since insulating sheet 2 is provided so as not to bring fire extinguishing sheet 3 into contact with tab 11, the area of insulating sheet 2 is preferably larger than that of fire extinguishing sheet 3.

As shown in FIG. 4, both end portions of insulating sheet 2 are fixed to inner surfaces 4a of structural members 4. Therefore, when fire extinguishing apparatus 1 is attached to battery cell 10, both end portions of insulating sheet 2 are located between side surface 10b of battery cell 10 and inner surfaces 4a of structural members 4.

Fire extinguishing sheet 3 is a rectangular sheet member and is made of an alkali metal which is a material capable of extinguishing fire caused by a vent gas. Examples of the alkali metal include, but are not limited to, potassium, sodium and the like.

As shown in FIGS. 1 to 3, fire extinguishing sheet 3 is disposed on insulating sheet 2. As shown in FIG. 4, both end portions of fire extinguishing sheet 3 are fixed to outer surfaces 4b of structural members 4. Although FIGS. 2 and 4 show fire extinguishing sheet 3 and insulating sheet 2 spaced apart from each other for the sake of clarity, fire extinguishing sheet 3 and insulating sheet 2 may be in contact with each other.

As a method of fixing each of insulating sheet 2 and fire extinguishing sheet 3 to structural members 4, for example, a method using a known adhesive or a method of imparting an adhesive force to the both end portions of each of insulating sheet 2 and fire extinguishing sheet 3 is exemplified, but is not limited thereto.

Structural members 4 are a columnar member having an arcuate top surface and a bottom surface (a shape of a part of an annular ring). Structural members 4 are made of a known material (for example, plastic or the like) having an insulating property and having strength.

As shown in FIGS. 1 to 4, two structural members 4 are used. Two structural members 4 correspond to an example of a fixing section. In addition, one of two structural members 4 corresponds to an example of a first fixing section, and the other corresponds to an example of a second fixing section.

As described above, the both end portions of insulating sheet 2 are fixed to inner surface 4a of structural member 4. More specifically, one end of insulating sheet 2 is fixed to inner surface 4a of one structural member 4, and the other end of insulating sheet 2 is fixed to inner surface 4a of other structural member 4 (see FIG. 4).

Further, as described above, the both end portions of fire extinguishing sheet 3 are fixed to outer surface 4b of structural member 4. More specifically, one end of fire extinguishing sheet 3 is fixed to outer surface 4b of one of structural members 4, and the other end of fire extinguishing sheet 3 is fixed to outer surface 4b of other structural member 4 (see FIG. 4).

In this way, insulating sheet 2 and fire extinguishing sheet 3 are fixed to both of two structural members 4 such that they are electrically insulated from one another (see FIG. 4).

When fire extinguishing apparatus 1 is attached to battery cell 10, two structural members 4 make contact with side surface 10b of battery cell 10 and are arranged so as to face each other with battery cell 10 interposed therebetween (see FIGS. 1 to 3).

Fire extinguishing apparatus 1 is attached to each battery cell 10, for example, when a plurality of battery cells 10 are modularized. Therefore, by manufacturing a plurality of fire extinguishing apparatuses 1 in the state shown in FIG. 4 in advance, a mounting work for the plurality of battery cells 10 is facilitated.

As described above, according to fire extinguishing apparatus 1 of Embodiment 1, battery cell 10 includes insulating sheet 2 disposed on tab 11 connected to the electrode at the mounting surface (for example, upper surface 10a) on which the electrode is mounted (which may also be referred to hereinafter as “electrode mounting surface”), fire extinguishing sheet 3 disposed on insulating sheet 2 and made of an alkali metal, and structural members 4 to which insulating sheet 2 and fire extinguishing sheet 3 are fixed in a state of being electrically insulated from each other.

Generally, when thermal runaway occurs, ignition often starts from the electrode mounting surface situated in the direction of ejection of the vent gas. However, in fire extinguishing apparatus 1 of Embodiment 1, since alkali-metal fire extinguishing sheet 3 is provided on the electrode mounting surface (upper surface 10a), the ignition by the vent gas can be suppressed (extinguished) for each tabbed battery cell. As a result, it is possible to contribute to suppression of the thermal propagation.

Further, since insulating sheet 2 and fire extinguishing sheet 3 are fixed to structural members 4 in advance, tabbed battery cell 10 can be easily retrofitted by inserting two structural members 4 along side surface 10b of battery cell 10.

Even when both the positive electrode and the negative electrode are provided on upper surface 10a of battery cell 10, the fire suppressing effect can be obtained by disposing fire extinguishing apparatus 1 of the present embodiment on battery cell 10.

### Embodiment 2

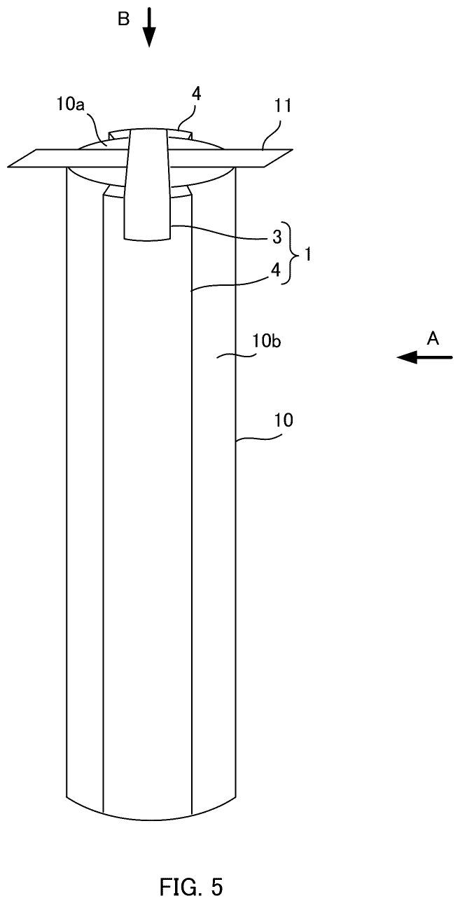

Fire extinguishing apparatus 1 and battery cell 10 according to Embodiment 2 will be described with reference to FIGS. 5 to 8.

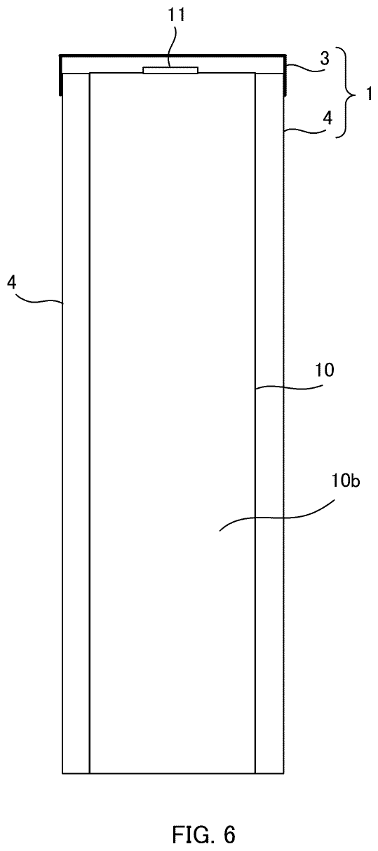

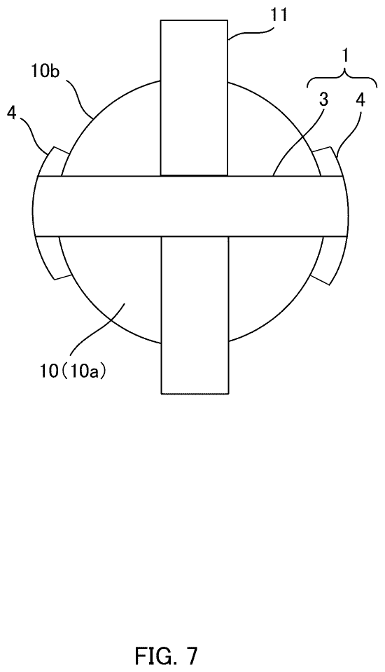

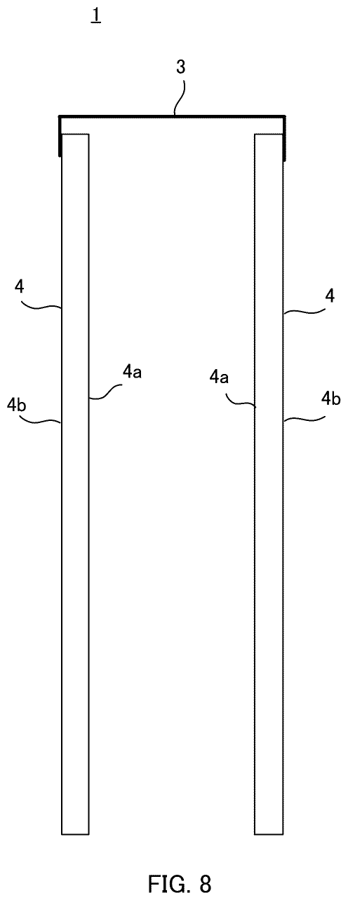

FIG. 5 is a perspective view schematically showing a state in which fire extinguishing apparatus 1 according to Embodiment 2 is attached to battery cell 10. FIG. 6 is a side view schematically showing a state in which fire extinguishing apparatus 1 according to Embodiment 2 is attached to battery cell 10 (a view seen from a direction indicated by arrow A in FIG. 5). FIG. 7 is a top view schematically illustrating a state in which fire extinguishing apparatus 1 according to Embodiment 2 is attached to battery cell 10 (a view seen from a direction indicated by arrow B in FIG. 5). FIG. 8 is a side view schematically illustrating fire extinguishing apparatus 1 according to Embodiment 2.

In FIGS. 5 to 8, components common to those in Embodiment 1 are denoted by the same reference numerals. Therefore, description thereof will be omitted and differences from Embodiment 1 will be described below.

As shown in FIGS. 5 to 8, fire extinguishing apparatus 1 of Embodiment 2 is different from that of Embodiment 1 in that it does not include insulating sheet 2.

Fire extinguishing sheet 3 shown in FIGS. 5 to 8 is formed of the above-described alkali metal (for example, potassium, sodium, or the like) and a known insulator (for example, resin or the like). Therefore, fire extinguishing sheet 3 of the present embodiment has not only a function of extinguishing fire caused by the vent gas but also a function of electrical insulation from an electrode (not shown).

Note that, as shown in FIG. 8, both end portions of fire extinguishing sheet 3 are fixed to outer surfaces 4b of structural members 4, but the present invention is not limited thereto and may be fixed to inner surfaces 4a.

As described above, according to fire extinguishing apparatus 1 of Embodiment 2, the fire extinguishing apparatus includes fire extinguishing sheet 3 disposed on tab 11 connected to the electrode on the electrode mounting surface (for example, upper surface 10a) of battery cell 10 and composed of an insulator and an alkali metal, and structural members 4 to which fire extinguishing sheet 3 is fixed.

Therefore, in fire extinguishing apparatus 1 according to Embodiment 2, as in Embodiment 1, since alkali-metal fire extinguishing sheet 3 is provided on the electrode mounting surface (upper surface 10a), ignition by the vent gas can be suppressed (extinguished) for each tabbed battery cell. As a result, it is possible to contribute to suppression of the thermal propagation.

Further, since fire extinguishing sheet 3 is fixed to structural member 4 in advance, tabbed battery cell 10 can be easily retrofitted by inserting two structural members 4 along side surface 10b of battery cell 10.

Even when both the positive electrode and the negative electrode are provided on upper surface 10a of battery cell 10, the fire suppressing effect can be obtained by disposing fire extinguishing apparatus 1 of the present embodiment on battery cell 10.

### <Variations>

The present disclosure is not limited to the descriptions of Embodiments 1 and 2, and various modifications can be made without departing from the gist of the present disclosure.

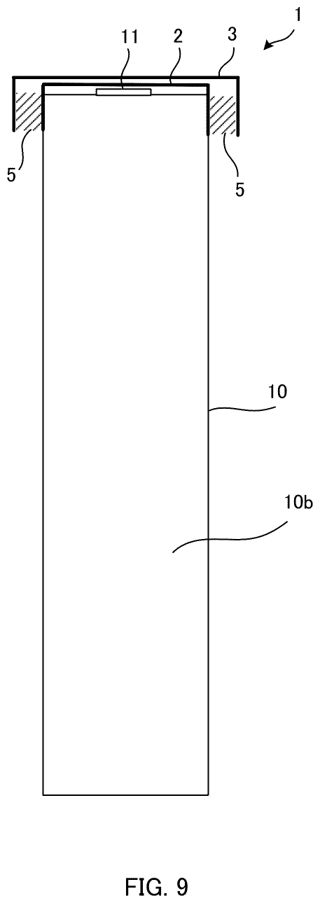

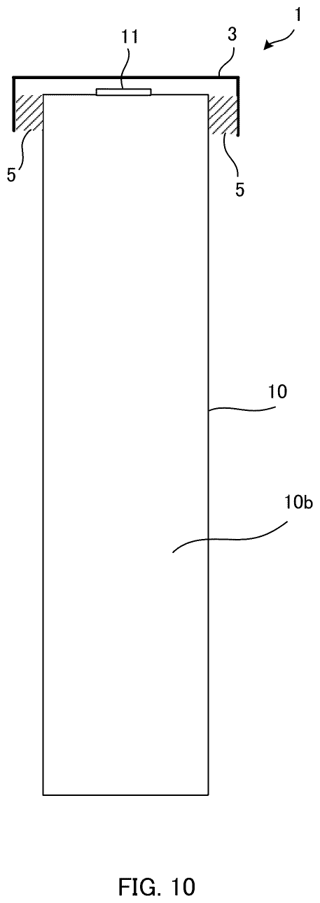

For example, in fire extinguishing apparatus 1 described in Embodiments 1 and 2, a binder may be used instead of structural members 4. Variations of Embodiments 1 and 2 will be described below with reference to FIGS. 9 and 10.

FIG. 9 is a side view schematically showing a state in which fire extinguishing apparatus 1 according to the variation of Embodiment 1 is attached to battery cell 10. FIG. 10 is a side view schematically showing a state in which fire extinguishing apparatus 1 according to the variation of Embodiment 2 is attached to battery cell 10.

Binder 5 shown in FIGS. 9 and 10 is formed of a material having an adhesive force and a known insulator.

As shown in FIGS. 9 and 10, two binders 5 are provided. Two binders 5 correspond to an example of the fixing section. In addition, one of two binders 5 corresponds to an example of the first fixing section, and the other corresponds to an example of the second fixing section.

In addition, two binders 5 shown in FIGS. 9 and 10 are arranged in the same manner as two structural members 4 described in Embodiment 1. That is, two binders 5 are arranged so as to face each other with battery cell 10 interposed therebetween when fire extinguishing apparatus 1 is attached to battery cell 10.

FIG. 9 will be described. As shown in FIG. 9, both end portions of each of insulating sheet 2 and fire extinguishing sheet 3 are bonded and fixed to two binders 5. At this time, insulating sheet 2 and fire extinguishing sheet 3 are fixed to each of two binders 5 in a state of being electrically insulated from each other.

In addition, in FIG. 9, as a method of fixing both end portions of insulating sheet 2 (specifically, the surfaces of the end portions on which binder 5 is not disposed) to side surface 10b of battery cell 10, for example, a method using a known adhesive or a method of imparting an adhesive force to both end portions of insulating sheet 2 is exemplified, but the present invention is not limited thereto.

In FIG. 9, the both end portions of insulating sheet 2 and fire extinguishing sheet 3 are bonded to two binders 5, and then the both end portions of insulating sheet 2 are bonded to side surface 10b of battery cell 10, whereby fire extinguishing apparatus 1 can be easily attached to battery cell 10.

FIG. 10 will be described. As shown in FIG. 10, two binders 5 are bonded and fixed to side surface 10b above battery cell 10. In addition, both end portions of fire extinguishing sheet 3 are bonded to and fixed respectively to two binders 5.

In FIG. 10, fire extinguishing apparatus 1 can be easily attached to battery cell 10 by first adhering both end portions of fire extinguishing sheet 3 to two binders 5 and then adhering two binders 5 to side surface 10b of battery cell 10.

Fire extinguishing apparatus 1 illustrated in FIGS. 9 and 10 described above can obtain the same operational effects as those of fire extinguishing apparatuses 1 of Embodiments 1 and 2.

### INDUSTRIAL APPLICABILITY

The fire extinguishing apparatus and the battery cell of the present disclosure are useful for suppressing ignition caused by a vent gas.

### REFERENCE SIGNS LIST

1 Fire extinguishing apparatus
2 Insulating sheet
3 Fire extinguishing sheet
4 Structural member
5 Binder
10 Battery cell
11 Tab (Bus bar)

1. A fire extinguishing apparatus, comprising:
an insulating sheet disposed on a tab at a mounting surface of a battery cell on which an electrode is mounted, the tab being connected to the electrode;
a fire extinguishing sheet disposed on the insulating sheet and formed of an alkali metal; and
a fixing section to which the insulating sheet and the fire extinguishing sheet are fixed in a state of being electrically insulated from each other.

2. The fire extinguishing apparatus according to claim 1, wherein:
the fixing section includes:
a first fixing section for fixing one end of each of the fire extinguishing sheet and the insulating sheet, and
a second fixing section for fixing another end of each of the fire extinguishing sheet and the insulating sheet, and
when the fire extinguishing apparatus is attached to the battery cell, the first fixing section and the second fixing section make contact with a side surface of the battery cell and are disposed to face each other with the battery cell being interposed therebetween.

3. The fire extinguishing apparatus according to claim 2, wherein
the first fixing section and the second fixing section are a structural member or a binder.

4. The fire extinguishing apparatus according to claim 1, wherein
the alkali metal is potassium or sodium.

5. A fire extinguishing apparatus, comprising:
a fire extinguishing sheet composed of an insulator and an alkali metal and disposed on a tab at a mounting surface of a battery cell on which an electrode is mounted, the tab being connected to the electrode; and
a fixing section to which the fire extinguishing sheet is fixed.

6. The fire extinguishing apparatus according to claim 5, wherein:
the fixing section includes:
a first fixing section for fixing one end of the fire extinguishing sheet, and
a second fixing section for fixing another end of the fire extinguishing sheet, and
when the fire extinguishing apparatus is attached to the battery cell, the first fixing section and the second fixing section make contact with a side surface of the battery cell and are disposed to face each other with the battery cell being interposed therebetween.

7. The fire extinguishing apparatus according to claim 6, wherein
the first fixing section and the second fixing section are a structural member or a binder.

8. The fire extinguishing apparatus according to claim 5, wherein
the alkali metal is potassium or sodium.

9. A battery cell, comprising:
the fire extinguishing apparatus according to claim 1.
